(19) United States
(12) Patent Application Publication
(10) Pub. No.: US 2015/0247558 A1
(43) Pub. Date: Sep. 3, 2015

(54) VENT STRUCTURE FOR TENSIONER

(71) Applicant: LITENS AUTOMOTIVE PARTNERSHIP, Woodbridge (CA)

(72) Inventors: Gerald J. Hamers, Woodbridge (CA); Gary J. Spicer, Mississauga (CA); Wei Ma, Richmond Hill (CA); Robert I. Boersema, King City (CA); Lucas E. Wilson, Toronto (CA)

(73) Assignee: LITENS AUTOMOTIVE PARTNERSHIP, Woodbridge, ON (CA)

(21) Appl. No.: 14/430,937

(22) PCT Filed: Sep. 23, 2013
(86) PCT No.: PCT/CN2013/083984

§ 371 Date: Mar. 25, 2015

Related U.S. Application Data
(60) Provisional application No. 61/705,493, filed on Sep. 25, 2012.

(51) Int. Cl. F16H 7/12; F02B 67/06

(52) U.S. Cl. CPC F16H 7/1218; F02B 67/06; F16H 2007/081

(57) ABSTRACT

A tensioner (24) for tensioning an endless drive member (14) on an accessory drive system or a cam shaft drive system is provided with a vent structure (99) that opens into a cavity (68) of the tensioner (24) to permit reduction of any pressure in the cavity (68) and the ambient environment of the tensioner (24), while inhibiting ingress of contaminants into the cavity (68). In some embodiments the vent structure (99) includes one or more of a mechanical one-way valve (152), a semi-permeable membrane (311) or a passageway with a circuitous path.

### CROSS-REFERENCE TO RELATED APPLICATIONS

This application claims the benefit of U.S. Provisional Patent Application Ser. No. 61/705,493 filed Sep. 25, 2012, the contents of which are incorporated herein by reference.

### FIELD

The present application relates to clutched devices, particularly tensioners, especially for use in vehicles.

### BACKGROUND

Tensioners are used in a variety of applications to apply tension to an endless drive member, such as a belt, that connects a driven rotary member and a drive member. One example of a tensioner in the automobile industry is used to maintain tension in a belt connecting a crankshaft pulley on a vehicle's engine to belt-driven accessories such as an alternator, a water pump, an air conditioning compressor, a power steering pump, and the like. A tensioner is also used to maintain tension in a timing belt that transfers rotary power from the engine's crankshaft to camshafts that control the operation the engine's intake and exhaust valves. Proper operation of the tensioner may increase belt life, the life of the belt-driven accessories in some instances, and can reduce belt-related noises such as belt squeal.

In operation, one or more springs in the tensioner reside in a chamber within the tensioner arm and apply a torque to the tensioner arm in a direction into the belt. Damping elements may be incorporated into the tensioner to assist the tensioner arm in resisting being thrown off the belt during instances when there is a sudden increase in belt tension, as can happen when torsional vibrations are transmitted to the belt through the pulley on the engine crankshaft.

The chamber in the tensioner assembly is typically sealed to the outside environment to prevent ingress of contaminants that would reduce effectiveness and life of the components of the tensioner. However, the action of the torsion spring and damping elements generates heat inside the tensioner, which increases pressure inside the tensioner, which may itself cause damage to some of the components.

Thus, there is a need for a tensioner in which this issue can be at least partially addressed.

### SUMMARY

There is provided a tensioner, comprising a base that is mountable to an engine block or other structural member, a tensioner arm that is pivotable with respect to the base wherein the base and the tensioner arm together define a cavity, a pulley rotatably mounted to the tensioner arm and configured for engaging an endless drive member, a tensioner spring mounted in the cavity that acts between the base and the tensioner arm to drive the arm in a free arm direction, and a vent structure that opens into the cavity and that permits at least partial equalization of pressure between the cavity and the ambient environment of the tensioner, while inhibiting ingress of contaminants into the cavity.

The vent structure may include a seal with an aperture that opens as a result of a higher pressure in the cavity than exists in the ambient environment and that closes when the pressure in the cavity is substantially the same as the pressure in the ambient environment.

The vent structure may include a membrane that permits the flow-through of gas between the cavity and the ambient environment. The membrane may have one-way permeability to water. The membrane may be arranged to permit water to flow through the membrane out of the cavity. The membrane may inhibit the flow of water through the membrane into the cavity. The membrane may be configured to inhibit water flow into the cavity. The membrane may be configured to inhibit lubricant flow therethrough out of the cavity. The membrane may be configured to inhibit ingress of contaminants into the cavity. The membrane may be configured to have a relatively lower permeability to the passage of oxygen therethrough into the cavity. The membrane may have a relatively higher permeability to the passage of oxygen therethrough out of the cavity.

The vent structure may include an aperture that passes between the cavity and the ambient environment. The aperture may be sized to permit the flow therethrough of gases. The membrane may inhibit the flow therethrough of contaminants when the base is mounted to the engine block. A portion of the aperture may be a groove that extends along an exterior surface of the base and that forms a closed channel when the base is mounted to the engine block. The aperture has an aperture wall that may include an oleophilic coating thereon to inhibit the flow of lubricant through the aperture.

The vent structure may be configured to inhibit the egress of lubricant out of the cavity. The vent structure may be configured to inhibit the ingress of water into the cavity. The vent structure may be configured to facilitate the egress of water out of the cavity.

### BRIEF DESCRIPTION OF THE DRAWINGS

A detailed description will now be provided by way of example only with reference to the attached drawings, in which:

FIG. 1 is an elevation view of an engine that includes a tensioner that includes a vent structure;

FIG. 2A is a magnified perspective view of the tensioner shown in FIG. 1;

FIG. 2B is a magnified sectional view of the tensioner of FIG. 1;

FIG. 3A is a top view of an embodiment of a mechanical one-way vent structure for the tensioner shown in FIG. 1;

FIG. 3B is a bottom view of the vent structure shown in FIG. 3A;

FIG. 3C is a sectional view of the vent structure depicted in FIG. 3A;

FIG. 3D depicts the vent structure of FIG. 3B under pressure from gases and vapor in the tensioner assembly;

FIG. 3E is a perspective view of the flexible of FIG. 3A under pressure from gases and vapor in the tensioner assembly;

FIG. 4A is a top view of another embodiments of a mechanical one-way vent structure for the tensioner shown in FIG. 1;

FIG. 4B is a bottom view of the vent structure shown in FIG. 4A;

FIG. 4C is a sectional view of the vent structure shown in FIG. 4A under pressure from gases and vapor in the tensioner;

FIG. 4D depicts the flexible seal of FIG. 4B under pressure from gases and vapor in the tensioner;

FIG. 4E is a perspective view of the flexible of FIG. 4A under pressure from gases and vapor in the tensioner;

FIG. 5A is a top view of yet another embodiment of a mechanical one-way vent structure for the tensioner shown in FIG. 1;

FIG. 5B is a sectional view of the vent structure depicted in FIG. 5A;

FIG. 5C is a sectional view of the vent structure depicted in FIG. 5A under pressure from gases and vapor in the tensioner;

FIG. 5D is a perspective view of the vent structure of FIG. 5A under pressure from gases and vapor in the tensioner;

FIG. 6A is a top view of yet another embodiment of a mechanical one-way vent structure for the tensioner shown in FIG. 1;

FIG. 6B is a sectional view of the vent structure depicted in FIG. 6A;

FIG. 6C is a sectional view of the vent structure depicted in FIG. 6A under pressure from gases and vapor in the tensioner;

FIG. 6D is a perspective view of the vent structure of FIG. 6A under pressure from gases and vapor in the tensioner;

FIG. 7 is a perspective view of an embodiment of a vent structure for the tensioner shown in FIG. 1, incorporating a semi-permeable membrane;

FIG. 8 is a sectional view of another embodiment of a vent structure for the tensioner shown in FIG. 1, incorporating a semi-permeable membrane;

FIG. 9A is a sectional perspective view of a portion of a tensioner having a venting structure that includes a circuitous path for venting pressure from within the tensioner;

FIG. 9B is a perspective view of a base of the tensioner of FIG. 9A showing portions of the circuitous path making up the vent structure;

FIG. 10A is a sectional side view of a portion of another tensioner having a venting structure that includes a circuitous path for venting pressure from within the tensioner; and,

FIG. 10B is a perspective view of the tensioner shown in FIG. 10A, showing portions of the circuitous path.

### DETAILED DESCRIPTION

In this specification and in the claims, the use of the article “a”, “an”, or “the” in reference to an item is not intended to exclude the possibility of including a plurality of the item in some aspects. It will be apparent to one skilled in the art in at least some instances in this specification and the attached claims that it would be possible to include a plurality of the item in at least some aspects.

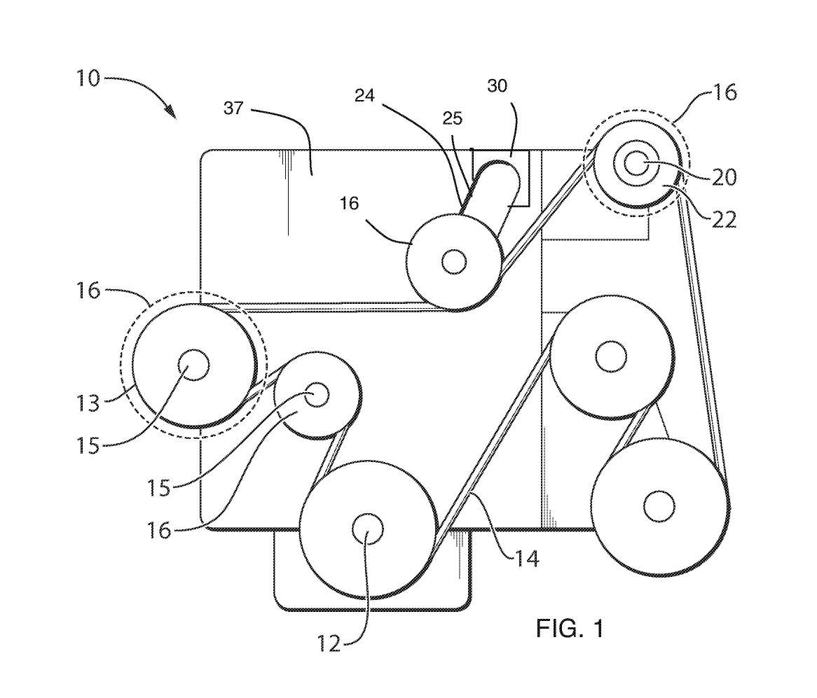

Reference is made to FIG. 1, which shows an engine 10 for a vehicle. The engine 10 includes a crankshaft 12 which drives an endless drive element, which may be, for example, a belt 14. Via the belt 14, the engine 10 drives a plurality of accessories 16 (shown in dashed outlines), such as an alternator and a compressor. Each accessory 16 includes an input drive shaft 15 with a pulley 13 thereon, which is driven by the belt 14. A decoupler 20 that includes its own pulley 22 may optionally be provided instead of a standard accessory pulley 13, between the belt 14 and the input shaft 15 of any one or more of the belt driven accessories 16, so as to automatically decouple the accessory's input shaft 15 from the belt 14 when the belt 14 decelerates relative to the shaft 15.

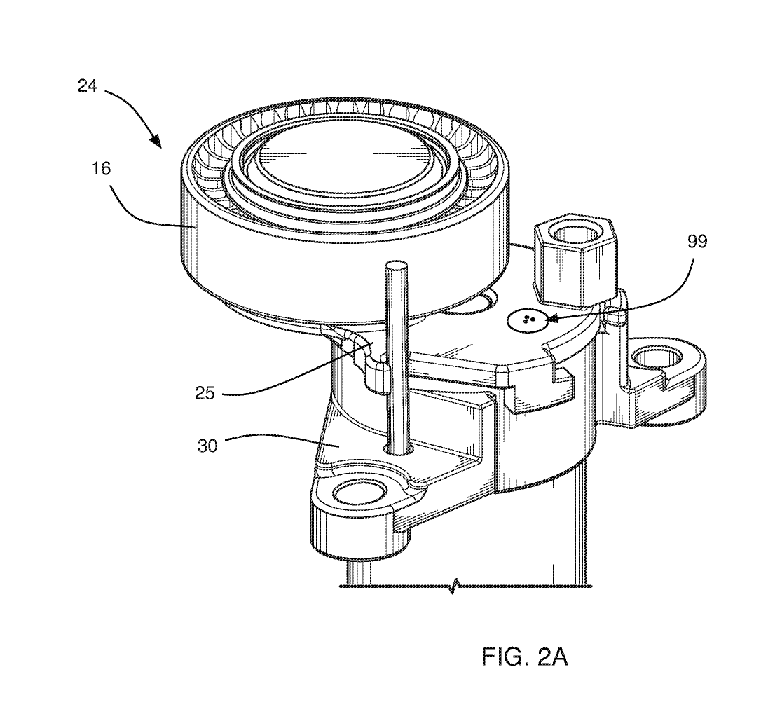

A tensioner 24 is provided and is mounted to the engine 10 for engagement with the belt 14 in order to maintain tension in the belt 14. The tensioner 24 is shown in more detail in FIGS. 2A and 2B.

The tensioner 24 may include a base 30 that mounts to the engine block shown at 37 or to some other stationary member, a tensioner arm 25 that is pivotally mounted to a spindle 29 that is part of the base 30 for pivotal movement about a tensioner arm axis AA. The tensioner 24 further includes a pivot bushing 27 positioned between the arm 25 and the base 30 (between the arm 25 and the spindle 29 specifically) to facilitate pivoting movement of the tensioner arm 25.

A wheel 16 (which may be, for example, a pulley) is mounted on the tensioner arm 25 for rotation about a wheel axis AW that is spaced from the tensioner arm axis AA. In FIG. 2A the wheel 16 is shown as having a smooth outer surface. In FIG. 2B an alternative wheel 16 is shown having a V-grooved outer surface for engagement with the V's on a poly-V belt. A bearing 18 rotatably supports the wheel 16 on the arm 25 for rotation about axis AW. A wheel fastener 35 is provided to hold the wheel 16 on the tensioner arm 25.

A tensioner spring 28 is positioned in a chamber 68 between the tensioner arm 25 and the base 30. The tensioner spring 28 biases the arm 25 in a direction towards the belt 14 so as to engage the wheel 16 with the belt 14 in order to maintain tension in the belt 14. In the embodiment shown the tensioner spring 28 is a torsion spring having a first end 31 that engages a first drive wall (not shown) on the base 30 and a second end 33 that engages a second drive wall (not shown) on the tensioner arm 25. The spring 28 may be axially compressed somewhat in the chamber 68. A thrust washer 32 and a thrust plate 34 are provided to resist axial forced exerted by the spring 28.

A damping structure 23 is provided to dampen movement of the tensioner 24 in particular during sudden increases in belt tension as can occur when torsional vibrations are transmitted into the belt 14 from the engine crankshaft 12.

A dust shield 14 is provided at the bottom of the tensioner 24 to seal against the migration of dust into a central aperture thereof.

The components of the tensioner 10 may be similar to the analogous components of the tensioner 10 shown in PCT publication WO2010037232 and US Patent publication US20090181815, the contents of both of which are incorporated herein by reference.

The belt may be any suitable type of belt, such as, for example, an asynchronous belt such as a single- or poly-V belt, or a synchronous belt that has teeth. While the term ‘belt’ may be used for convenience, it will be noted that any endless drive member may be used.

Some examples of problems that can occur with a tensioner 24 if the cavity 68 becomes overpressurized and/or if certain contaminants are permitted to make their way into the cavity include:
1. Negatively affecting the damping coefficient of the damping mechanism, via impartation of unwanted and unpredictable lubrication qualities;
2. Allowing for the initiation of corrosion and oxidation of any steel and aluminum components;
3. Allowing for the flow and travel of contamination into damping interfaces, resulting in the increased potential for stiction and seizing of the various moving damping interfaces;
4. Allowing for the uncontrolled absorption of water by any internal plastic damping components, resulting in unpredictable swelling of the plastic components, and the negative impact on the attendant tolerances; and
5. Allowing for the build-up and release of internal pressures within the tensioner 24 during repetitive engine heating and cooling cycles, resulting in unwanted expansion and movement and loading of the various tensioner components.

With reference to FIG. 2A, a vent structure 99 is provided for the tensioner 24 to permit venting of the cavity 68 in the tensioner 24 to prevent the cavity 68 from becoming overpressurized and, in some embodiments performs one or more of: inhibiting contaminants from entering the cavity 68 and inhibiting lubricant in the cavity 68 (if there is any) from leaving the cavity 68. Put another way, in some embodiments, the vent structure 99 opens into the cavity 68 and permits at least partial equalization of pressure between the cavity 68 and the ambient environment of the tensioner 24, while inhibiting ingress of contaminants into the cavity 68.

The term contaminant is intended to be interpreted broadly, and may include particulate, such as dust and debris, liquids such as liquid water, and gases, such as oxygen in some cases. The vent structure (which may simply be referred to as the ‘vent’) may be provided in several different forms.

### Vent Provided by Mechanical Seal

In some embodiments, the vent structure 99 includes a seal member with an aperture that is self-closing when the pressure in the cavity 68 and the pressure in the ambient environment outside the tensioner 24 are substantially equal, but that opens to permit the venting of increased pressure that develops in the cavity.

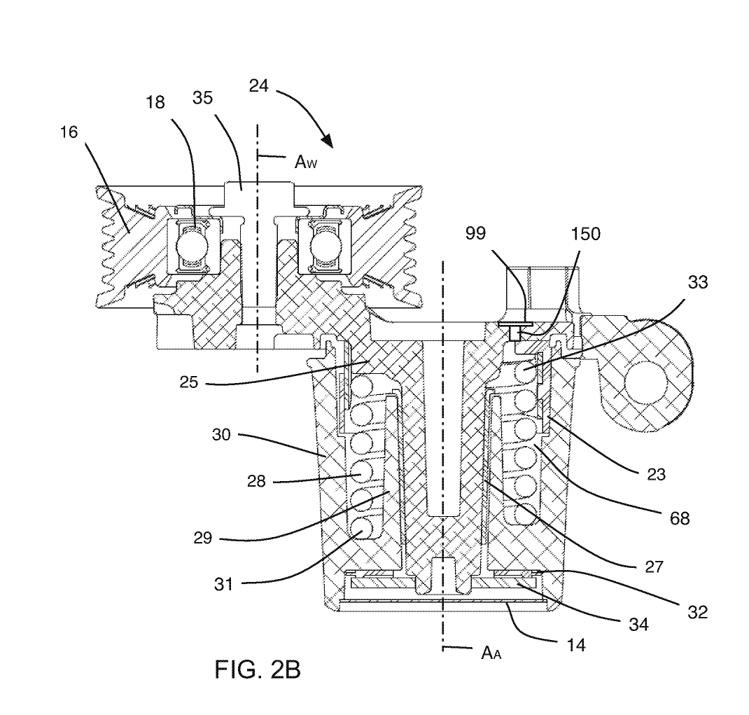

An example of this is shown in FIGS. 3A-3E. In the embodiment shown in FIGS. 3A-3E, a seal member 152 is mounted on a seal bearing surface 151 that is optionally in a shallow recess in the tensioner arm 25 and covers a vent aperture 150 that extends from outside of the tensioner 24 into the cavity 68. The seal member 152 may be made from any suitable material such as an elastomeric material, such as rubber. The seal member 152 is sealingly fixed to the surface 151, for example, with the use of an adhesive, except in a region 153 surrounding the aperture 150. The seal member 152 may have one or more seal member vent apertures 155, which are not directly over the aperture 150 but which are over the region 153, as best seen in FIGS. 3C and 3D. As can be seen in FIG. 3C, when the pressure in the chamber 68 is substantially equal to the ambient pressure outside the tensioner 24, the seal member 152 lies in abutment with the surface 151 in the region 153 such that the vent apertures 155 abut the surface 151 and are therefore substantially blocked from fluid communication with the aperture 150. The vent holes 155 are therefore sealed by the surface 151 preventing ingress of contaminants into the cavity 68 when the pressure inside the tensioner 24 is not great enough to cause venting.

As seen in FIGS. 3D and 3E, when a suitable pressure within the chamber 68 (FIG. 2a) behind the seal member 152 increases sufficiently, the pressure may deform the seal member 152 above the aperture 150 creating a protuberance 157 in the seal member 152 because the seal member 152 is sealingly fixed to the outer surface of the surface 151 except above the aperture 150 and the region 153. With the creation of the protuberance 157 under pressure, the vent holes 155 are lifted away from the surface 151 and gases and vapor may escape through the vent holes 155 (as illustrated by the arrows in FIG. 3D). Pressure of escaping gases and vapor inhibit ingress of contaminants into the tensioner 24 while the protuberance 157 is present (i.e. while the vent apertures 155 are lifted away from the surface 151).

The amount of pressure in the chamber 68 that is needed before the seal member 152 lifts away from the surface 151 may be controlled by the properties of the flexible seal member 152 (e.g. durometer and thickness) and the size of the region 153 of the surface 151 that is not adhered to the seal member 152. In other words, selection of the durometer and thickness of the seal member 152 and the size of the region 153 permits adjustment of the pressure required to create the protuberance 157, and therefore adjustment of the desired level of pressure buildup in the chamber 68 before venting occurs.

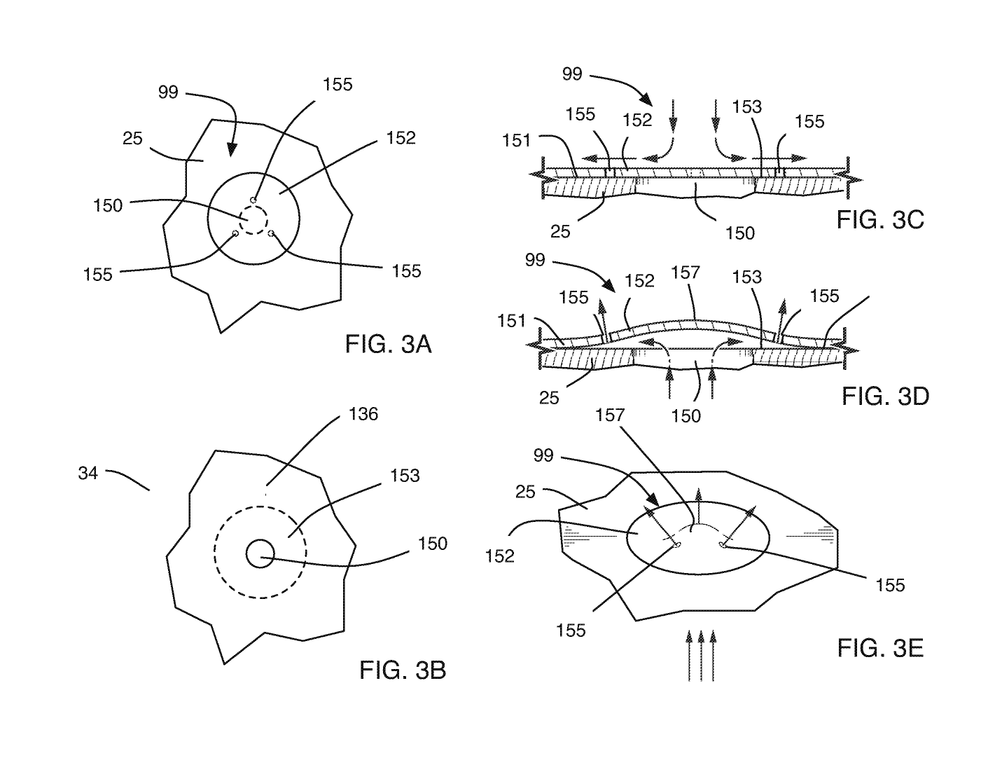

Another embodiment of a vent structure 99 is shown in FIGS. 4A-4E. In this embodiment the apertures 155 are formed by slits 165 in the flexible seal member 152 that separate a valve region 163 of the seal member 152 from the remainder of the seal member 152. The flexible seal member 152 may be sealingly fixed to the seal bearing surface 151, for example with the use of an adhesive, except in the rectangular valve region 163 which surrounds the aperture 150. The vent slits 165, which are not directly over the aperture 150 but are over or directly adjacent to the region 163, as best seen in FIGS. 4C and 4D

As seen in FIG. 4C, because the vent slots 165 in the seal member 152 are located above or directly adjacent to the region 163, when the pressure is equalized between an outer environment and the chamber 68, no protuberance is formed and the flexible seal member 152 lies flat against the surface 151. The vent slits 165 are therefore sealed by engagement the surface 151 preventing ingress of contaminants into the tensioner 24 through the aperture 150 (see arrows).

As seen in FIGS. 4D and 4E, when pressure in the chamber 68 increases sufficiently, the pressure may deform the flexible seal member 152 above the aperture 150 creating a protuberance 167 in the flexible seal member 152 because the seal member 152 is sealingly fixed to the outer surface of the surface 151 except above the aperture 150 and the region 163. With the creation of the protuberance 167 under pressure, the vent slits 165 may be opened as the seal in region 163 under or to one side of the slits 165 may lift away from the surface 151 and gases and vapor may escape through the vent slits 165 (see arrows). Pressure of escaping gases and vapor prevent ingress of contaminants into the chamber 68 while the protuberance 167 is present.

The amount of pressure in the chamber 68 that is needed before the seal member 152 lifts away from the surface 151 is controlled by properties of the seal member 152, such as durometer and thickness, and the size of the region 163. Tuning the durometer and thickness of the seal member 152 and the size of the region 163 permits adjustment of the pressure required to create the protuberance 167.

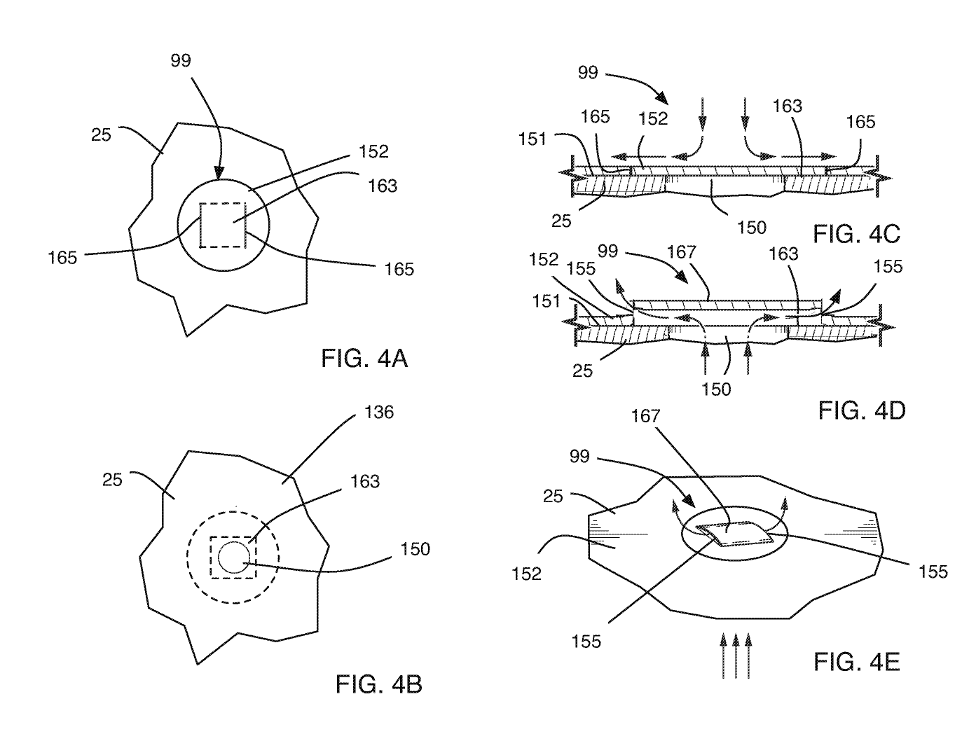

With reference to FIGS. 5A-5D, in another embodiment the entire seal member 152 is adhered to the surface 151 of the tensioner arm 25 except directly over the aperture 150 is required as an opening in the seal member 152 is directly over the aperture 150 in the surface 151. The seal member 152 may comprise a vent slit 175, which is over the aperture 150, as best seen in FIGS. 5B and 5C. The vent slit 175 is bounded by regions 177a, 177b of the seal member 152 that are over the aperture 150 and not fixed to the surface 151. As seen in FIGS. 5C and 5D, when pressure in the chamber 68 increases sufficiently, the pressure may deform the seal member 152 above the aperture 150 opening the vent slit 175 by deflecting edges of the regions 177a, 177b of the seal member 152 away from each other. Only the regions 177a, 177b of the seal member 152 are deformed because the remainder of the seal member 152 is sealingly fixed to the outer surface 151 except above the aperture 150. With the deflection of the regions 177a, 177b under pressure, the vent slit 175 opens and gases and vapor may escape through the vent slit 175. Pressure of escaping gases and vapor prevent ingress of contaminants into the chamber 68 while the regions 177a, 177b are deflected. As seen in FIG. 5B, because the edges of the regions 177a, 177b forming the vent slit 175 in the seal member 152 abut each other when the pressure is equalized between an outer environment and the inside of the tensioner 24 the vent slit 175 is closed preventing ingress of contaminants into the tensioner 24 when the pressure inside the tensioner 24 is not great enough to cause venting. Since the pressure in the tensioner 24 should not be lower than the pressure in the outer environment, a reverse flow of gases and vapor into the tensioner 24 should not occur. The pressure in the chamber 68 at which the slit 175 opens may be controlled by the design of the seal member 152 (e.g. durometer and thickness) and the size of the aperture 150. Tuning the durometer and thickness of the seal member 152 and the size of the aperture 150 permits adjustment of the pressure required to deflect the regions 177a, 177b of the seal member 152, and therefore adjustment of the desired level of pressure relief.

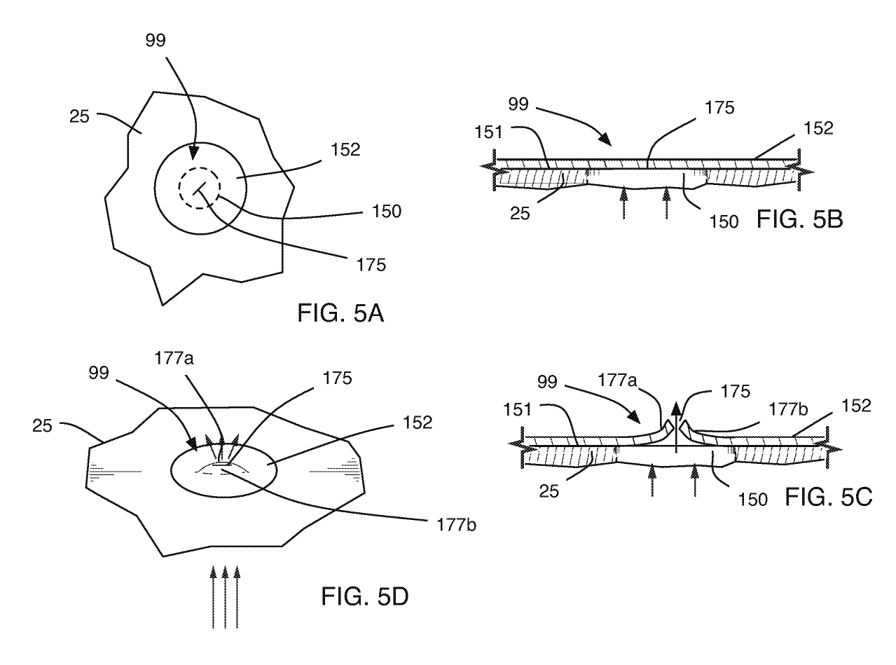

With reference to FIGS. 6A-6D, in another embodiment of the vent structure 99, a two-part valve member 260 is nested within a shallow recess in the tensioner arm 25 and covers the aperture 150. As seen in FIG. 6B, the valve member 260 comprises a flexible sealing tab 261, for example made of an elastomeric material, sealingly fixed to an upper surface of a rigid valve member base 262, for example made of a rigid plastic material, having a valve member base aperture 265 therein. The flexible sealing tab 261 is sealingly fixed to the rigid base 262 along a perimeter of the sealing tab 261 leaving a portion 263 of the perimeter un-fixed to the rigid label base 262. The aperture 265 aligns with aperture 150 in the tensioner arm 25 when the valve label 260 is nested in the aperture 250 in the cover seal 252, as best seen in FIG. 6D. The valve member 260 may be sealingly fixed on the surface 151 over the aperture 150 in any suitable fashion, for example by over-molding or an adhesive.

As seen in FIGS. 6C and 6D, when pressure in the chamber 68 increases sufficiently, the pressure may deform the flexible sealing tab 261 above the aperture 150 into a protuberance 267 in the flexible sealing tab 261 because the flexible sealing tab 261 is sealingly fixed to the outer surface of the rigid label base 262 except above the aperture 150 and the portion 263 of the perimeter of the flexible sealing tab 261 not fixed to the rigid label base 262. With the formation of the curved rectangular protuberance under pressure, the portion 263 of the perimeter of the flexible sealing tab 261 may lift away from the rigid label base 262 providing vents 264 through which gases and vapor may escape. Pressure of escaping gases and vapor prevent ingress of contaminants into the tensioner 24 while the protuberance 267 is present. As seen in FIG. 6C, when the pressure is equalized between an outer environment and the chamber 68, no protuberance is formed and the flexible sealing tab 261 lies flat against the rigid label base 262. The vents 264 are therefore sealed by the rigid label base 262 preventing ingress of contaminants into the tensioner 24 when the pressure inside the chamber 68 is not great enough to cause venting. The pressure at which the flexible sealing tab 261 opens may be controlled by the design of the flexible sealing tab 261 (e.g. durometer and thickness) and the size of the portion 263 of the perimeter of the flexible sealing tab 261 left un-fixed. Tuning the durometer and thickness of the flexible sealing tab 261 and the size of the portion 263 permits adjustment of the pressure required to form the curved rectangular protuberance, and therefore adjustment of the desired level of pressure relief.

### Vent Provided by Membrane

In some embodiments, the vent structure 99 includes a membrane, (e.g. a semi-permeable membrane) that permits flow-through of air into and out of the cavity 68 but that prevents the pass-through of contaminants and moisture into the cavity 68.

In embodiments where lubricant exists in the cavity 68, the membrane may be selected to be oleophobic. This may be provided by the membrane itself (i.e. the membrane may have inherent oleophobic properties, optionally by way of an oleophobic substance incorporated within it) and/or it may be provided with an oleophobic coating. An oleophobic membrane will inhibit any lubricant in the cavity from adhering to the membrane thereby reducing the likelihood of any lubricant passing through the membrane to the exterior of the tensioner 24, and also inhibits clogging of the membrane. Other surfaces in the cavity 68 may be coated with an oleophilic coating that promotes the adherence of lubricant thereto, or an oleophobic coating to inhibit the adherence of lubricant thereto, so as to control where lubricant stays and doesn't stay within the cavity 68. Oleophobic membranes are commercially available and may be obtained from Nitto Denko Automotive, Inc., Donaldson Company, Inc., Pan Asian Micro-vent Tech (Changzhou) Co., Ltd. or Able Seal & Design Inc., for example.

U.S. Pat. No. 4,384,725 is hereby incorporated by reference in its entirety. The structure described in that patent includes an oleophobic coating used to assist with preventing the escape of a liquid lubricant from a bearing. Concepts in the '725 patent can be applied to the structure shown in the figures.

Additionally, hydrophobic and/or hydrophilic coatings can be used on the membrane and on other surfaces in the clutched device cavity to control how easily water (both in liquid form and in vapour form) is passed through the membrane. The membrane can be configured to have ‘one-way’ permeability to something such as water, in the sense that it will permit water to pass through the membrane in one direction but not in the other. As a result, any water that migrates into the cavity 68 may be permitted to leave the cavity 68 through the membrane, but water is inhibited from entering the cavity 68 though the membrane. In some embodiments, the membrane may be permeable to water vapour but may be relatively impermeable to liquid water.

Another example is oxygen, whose presence in the cavity 68 can lead to oxidation of the surfaces in the cavity 68. The membrane may be configured to have one-way permeability to oxygen that facilitates the flow of oxygen out of the cavity but that inhibits the flow of oxygen into the cavity 68. Thus, the cavity 68 may have a relatively low concentration of oxygen therein, as compared to the ambient environment.

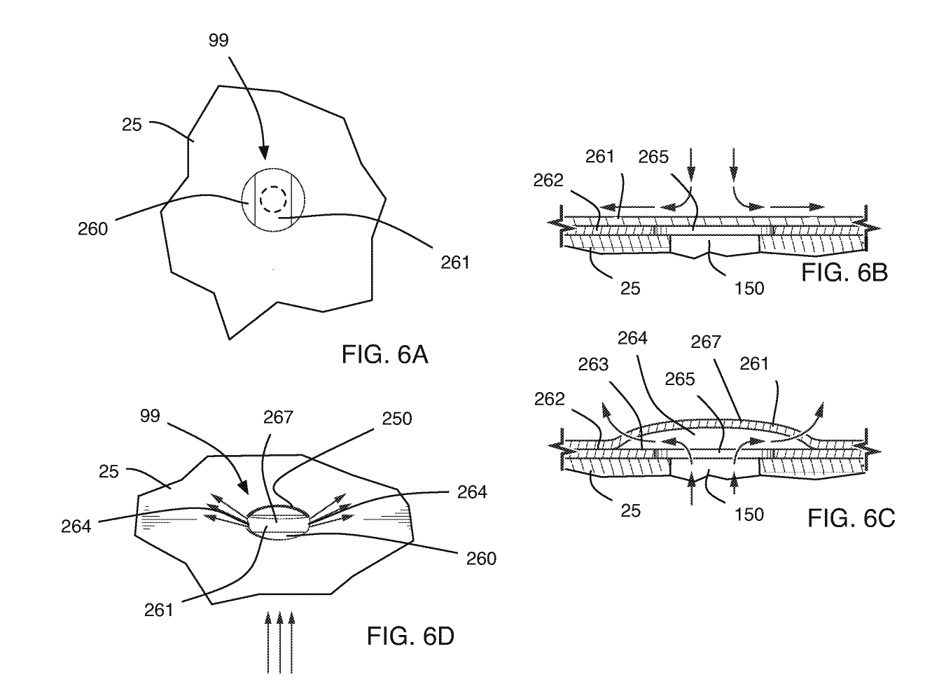

In an embodiment the vent structure 99 may be as shown in FIG. 7 wherein the vent structure 99 includes a semi-permeable membrane 301 (e.g. made of (e.g. expanded polytetrafluoroethylene (ePTFE)) is sealingly fixed on the outer surface 151 of the tensioner arm 25 over the aperture 150 in the backing plate 136. The membrane 301 is mounted (e.g. via adhesive) to surface 151 in the shallow recess in the tensioner arm 25 and covers aperture 150. The semi-permeable membrane 301 permits passage of gases into and out of the tensioner 24, but blocks the passage of solids (e.g. dust) and liquids (e.g. water and lubricant. When the air pressure inside the chamber 68 increases due to increasing temperature, gases may leave the chamber 68 through the membrane 301. When the air pressure inside the chamber 68 subsequently reduces as the temperature cools, gases may re-enter the chamber 68 thereby preventing a vacuum effect. While an oleophobic membrane may be used, if under-hood conditions do not necessitate an oleophobic membrane, a hydrophobic membrane could be used instead, which prevents water and other high surface tension fluids from entering the tensioner 24.

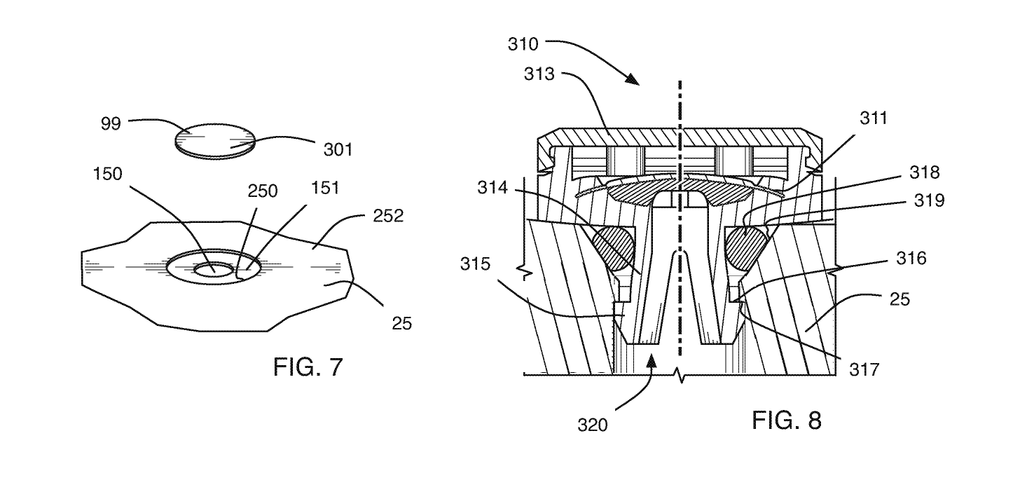

In another embodiment the vent structure 99 may be as shown in FIG. 8 in which a snap-in vent 310 with a semi-permeable membrane 311 inserted through an initial portion 320 of the aperture 150 in the tensioner arm 25. Snap-in vents of this nature are commercially available, for example from W. L. Gore & Associates, Inc of Newark, Del. The snap-in vent 310 comprises the membrane 311 housed in a vent body 312 covered by a cover 313. The vent body 312 comprises a stem 314 having an outwardly extending annular snap ring 315 for mating connection with the installation housing 320. When the vent 310 is snapped into the end cap 34, an upper surface 316 of the snap ring 315 engages a shoulder 317 to prevent the vent 310 from being withdrawn from the aperture 150. The vent 310 is further secured snugly and sealingly in the aperture portion 320 by an o-ring 318. While an oleophobic membrane is commonly used (e.g. ePTFE), if under-hood conditions do not necessitate an oleophobic membrane, a hydrophobic membrane could be used instead, which prevents water and other high surface tension fluids from entering the tensioner 24.

Vent Provided by passageway

In other embodiments, a passageway that extends from the cavity 68 out to the ambient environment, optionally along a path that is circuitous may be provided. The passageway may be sized to permit gases to flow through it to equalize the pressure between the cavity 68 and the ambient environment, but the circuitous path of the aperture inhibits the entry of contaminants into the cavity 68 therethrough, and also inhibits the flow of water therethrough into the cavity 68. To assist in preventing water to flow into the cavity 68 a hydrophilic coating may be applied to the surfaces of the aperture. Because the coating holds on to water when it is contacted by water, it resists the flow of water therepast. To assist in preventing the flow of lubricant (e.g. oil, grease) out of the cavity 68, the walls of the aperture may be coated with an oleophilic coating, which holds on to oils and the like and thus resists their flow through the aperture, thereby assisting in retaining the lubricant in the cavity 68. The surfaces in the cavity 68 may themselves also be coated to inhibit the oil from reaching the membrane at all. For example, if the lubricant is used between friction surfaces of a damping structure, oleophilic coatings may be used on one or both of those friction surfaces, and an oleophobic coating may be used on other surfaces in the cavity 68 to inhibit oil from remaining on them.

A feature of the path that may be used may be similar to a P-trap in the plumbing industry such that some water would, under gravity, sit in a U-shaped portion of the path and would not progress through the path to the end (i.e. would not drain fully from the path).

In an embodiment, one or more apertures are provided in the bottom of the tensioner (i.e. through the base) at the clamp interface where the tensioner base is bolted to the engine. The holes would intersect with one or more slots molded or machined into the base at the clamp interface between the tensioner base and the engine casting and/or mounting plate.

The orientation and direction of the slots relative to gravity may play a role in the selection of the orientation for the vent slot.

To prevent water or contamination ingress to flow backwards into the tensioner, any such slots would be formed in a labyrinth (also referred to as a tortuous flow path or a circuitous flow path) (e.g. such as a path with many changes in direction or a zig zagged path) in order to mechanically impede the flow or capillary movement action of water back into the tensioner therethrough. This improves the resistance of the tensioner to water that could result from the vehicle negotiating a body of water, or alternatively, as a result of high velocity water impingement resulting from normal road spray and/or vehicle power washing and underbody spray operations.

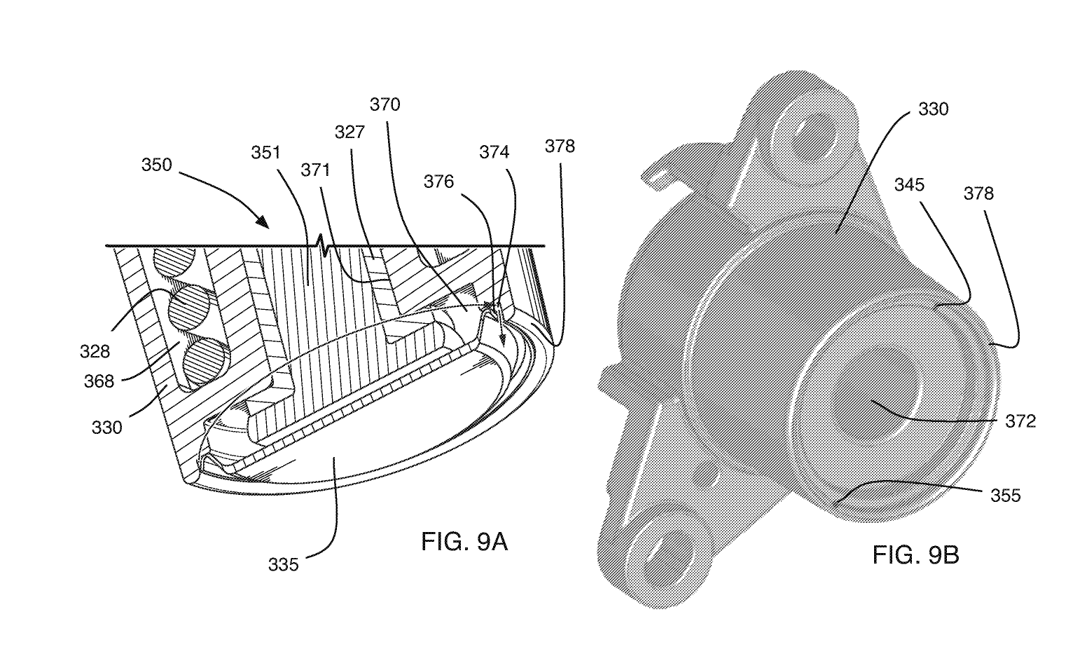

With reference to FIGS. 9A-9B, in an embodiment of a vent structure comprising a circuitous path, a tensioner 350 is shown and may be similar to the tensioner 24, comprising a base 330 mounted to which is a tensioner arm (not shown) via a fastener 351. The tensioner arm pivots on the base 330 via a pivot bushing 327 and may in general be similar to tensioner arm 25. The base 330 in part (along with the tensioner arm) defines a chamber or cavity 368 in which a tensioner spring 328 is provided. An end cap 334 is fitted into an end of the base 330, covering a bottom hollow region 370 of the base 330 that communicates with the chamber 368 through fastener pass-through aperture 372 (i.e. which is the aperture that the fastener 351 passes through to connect to the tensioner arm (not shown)).

The circuitous path through which air can escape from the cavity 368 is formed by the path between the fastener 351 and the pivot bushing 327 (and/or between the pivot bushing 327 and the wall 371 of the aperture 372, which leads from the chamber 368 to the bottom hollow region 370 of the base 330, a slot 345 that extends from the bottom hollow region 370 to an annular space 374 under a peripheral lip 376 of the cap 335, and finally a slot 355 that extends along a lip 378 of the base 330. Thus, air under pressure in the cavity 368 is able to escape to the ambient environment through the aforementioned path. When pressure in the cavity 310 is equilibrated with the ambient environment, contaminants, including liquid water, have difficulty negotiating the circuitous path to enter the cavity 368.

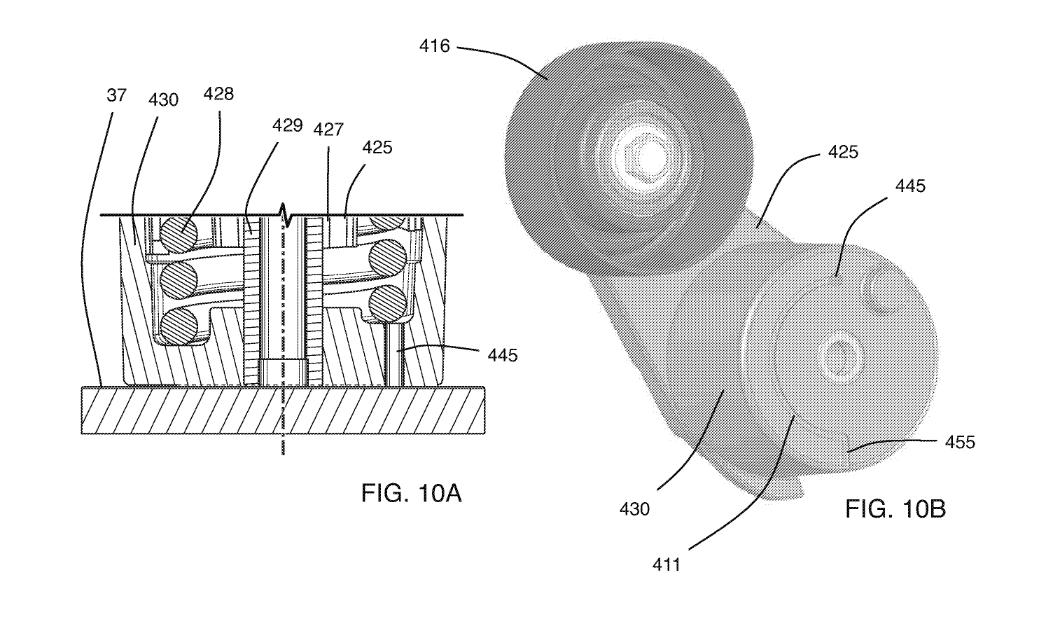

With reference to FIGS. 10A-10B, in another embodiment of a vent structure comprising a circuitous path, a tensioner assembly 400 comprises a base 430 extending from which is a tensioner arm 420 on which a pulley 416 is rotatably supported, the base 430 housing a wrap spring 428 in a cavity 468. A spindle 429 extends upwards from a bottom of the base 430. A tensioner arm 425 is pivotably mounted on the spindle 429, and a pivot bushing 427 is disposed between the spindle 429 and the tensioner arm 425 to facilitate pivoting movement of the arm 425.

The circuitous path through which air can escape from the cavity 468 includes a cavity aperture 445 in fluid communication with the cavity 468 and a curved groove 411 on an exterior surface at a bottom of the base 330 in fluid communication with an exit aperture 455 to the ambient environment. The curved groove 411 is sealed and forms a closed channel when the bottom of the base 330 is mounted on an engine block 37. Thus, air under pressure in the cavity 468 is able to escape the ambient environment through the exit portion 455. When pressure in the cavity 468 is equilibrated with the ambient environment, contaminants, including water, have difficulty negotiating the circuitous curved groove 411 to enter the cavity 468.

It will be noted that one of more of the vent structures described above may be provided in combination with each other, either in series (whereby one vent structure would connect from the cavity to another vent structure, which would in turn connect to the exterior of the tensioner), or in parallel (whereby each vent structure connects independently between the cavity and the exterior of the tensioner.

While the above description constitutes a plurality of aspects, it will be appreciated that the examples shown and described herein are susceptible to further modification and change without departing from the fair meaning of the accompanying claims.

1. A tensioner, comprising:
a base that is mountable to an engine block or other structural member;
a tensioner arm that is pivotable with respect to the base wherein the base and the tensioner arm together define a cavity;
a pulley rotatably mounted to the tensioner arm and configured for engaging an endless drive member;
a tensioner spring mounted in the cavity that acts between the base and the tensioner arm to drive the arm in a free arm direction; and
a vent structure that opens into the cavity and that permits at least partial equalization of pressure between the cavity and the ambient environment of the tensioner, while inhibiting ingress of contaminants into the cavity.

2. A tensioner as claimed in claim 1, wherein the vent structure includes a seal with an aperture that opens as a result of a higher pressure in the cavity than exists in the ambient environment and that closes when the pressure in the cavity is substantially the same as the pressure in the ambient environment.

3. A tensioner as claimed in claim 1, wherein the vent structure includes a membrane that permits the flow-through of gas between the cavity and the ambient environment.

4. A tensioner as claimed in claim 3, wherein the membrane has a one-way permeability to water, and is arranged to permit water to flow through the membrane out of the cavity but to inhibit the flow of water through the membrane into the cavity.

5. A tensioner as claimed in claim 3, wherein the membrane is configured to inhibit water flow into the cavity.

6. A tensioner as claimed in claim 3, wherein the membrane is configured to inhibit lubricant flow therethrough out of the cavity.

7. A tensioner as claimed in claim 3, wherein the membrane is configured to inhibit ingress of contaminants into the cavity.

8. A tensioner as claimed in claim 3, wherein the membrane is configured to have a relatively lower permeability to the passage of oxygen therethrough into the cavity but and a relatively higher permeability to the passage of oxygen therethrough out of the cavity.

9. A tensioner as claimed in claim 1, wherein the vent structure includes an aperture that passes between the cavity and the ambient environment, wherein the aperture is sized to permit the flow therethrough of gases but to inhibit the flow therethrough of contaminants when the base is mounted to the engine block.

10. A tensioner as claimed in claim 9, wherein a portion of the aperture is a groove that extends along an exterior surface of the base and that forms a closed channel when the base is mounted to the engine block.

11. A tensioner as claimed in claim 9, wherein the aperture has an aperture wall that includes an oleophilic coating thereon to inhibit the flow of lubricant through the aperture.

12. A tensioner as claimed in claim 1, wherein the vent structure is configured to inhibit the egress of lubricant out of the cavity.

13. A tensioner as claimed in claim 1, wherein the vent structure is configured to inhibit the ingress of water into the cavity.

14. A tensioner as claimed in claim 1, wherein the vent structure is configured to facilitate the egress of water out of the cavity.

15. A tensioner as claimed in claim 13, wherein the vent structure is configured to facilitate the egress of water out of the cavity.
